(19) United States
(12) Patent Application Publication
(10) Pub. No.: US 2014/0216065 A1
(43) Pub. Date: Aug. 7, 2014

(54) METHOD FOR THE RECOVERY OF VENT GASES FROM STORAGE VESSELS

(71) Applicants: Paul Jarrett, Leeds (GB); Ron C. Lee, Bloomsbury, NJ (US)

(72) Inventors: Paul Jarrett, Leeds (GB); Ron C. Lee, Bloomsbury, NJ (US)

(21) Appl. No.: 14/060,681

(22) Filed: Oct. 23, 2013

Related U.S. Application Data
(60) Provisional application No. 61/717,162, filed on Oct. 23, 2012.

(51) Int. Cl. B01F 15/02; F17C 9/04

(52) U.S. Cl. CPC B01F 15/0248; F17C 9/04; F17C 2221/032; F17C 2223/0161; F17C 2225/0161; F17C 2227/0114; F17C 2260/031; F17C 2265/034
USPC 62/48.1

(57) ABSTRACT

A method for removing gas from a storage vessel and returning it along with a liquid feed to the vessel. The gas such as natural gas is withdrawn from the storage vessel and fed to a venturi device where it is combined with a feed of liquid to the venturi device. The gas will combine with the liquid feed in the venturi device while the pressure in the storage vessel will be decreased thereby reducing the need for venting and increasing efficiency of the storage vessel.

### CROSS REFERENCE TO RELATED APPLICATIONS

This application claims priority from U.S. Provisional application Ser. No. 61/717,162 filed Oct. 23, 2012.

### BACKGROUND OF THE INVENTION

The invention provides for a method for using a venturi device to mix gas such as natural gas from a storage vessel or tank such as that onboard a vehicle with a feed of liquid such as liquefied natural gas (LNG) for feeding back into the storage vessel or tank.

Natural gas is seeing increasing use as a fuel alternative to combustion fuels such as gasoline and diesel and avoids certain drawbacks such as production cost and combustion emissions that these other fuels possess. Natural gas is relatively inexpensive compared to conventional motor vehicle fuels. Natural gas burns cleaner than gasoline or diesel and will rise up in the air and dissipate adding to its safety, thus making it attractive in relation to federal emission and pollution laws.

Liquefied natural gas is stored on vehicles in vessels that must account for it being a cryogenic fluid and having a normal boiling point below −160° C. Double walled and insulated tanks are the norm but during periods of non-use, heat flows to the liquefied natural gas which will cause it to vaporize and build pressure in the storage vessel. This pressure build up must be dealt with by venting. This problem with boil-off and necessary venting is further exacerbated by losses suffered during fueling and onboard storage resulting in economic loss and environmental concerns. These are undesirable conditions due to the potential environmental harms as well as the obvious economic losses.

Storage vessels are typically cryogenic liquid cylinder pressure vessels that are vacuum-jacketed and super-insulated, The vessels are equipped with all the necessary piping and controls to safely provide gaseous natural gas produced by vaporizing the liquefied natural gas to a vehicle fuel system. These piping and controls typically include a vaporizer, regulator and safety shut off valve.

These systems do not typically contain a system to maintain pressure in the vessel as the liquefied natural gas is withdrawn. These vessels are typically filled from the top such that fresh liquefied natural gas can only be fed into the vapor space of the vessel in order to condense the vapor and maintain reduced storage pressures. There is commonly a non-return valve in the fill line.

Consequently, several problems are associated with this type of system design. As the temperature of the fresh liquefied natural gas feed increases, there is less cold available to collapse the pressure in the storage vessel. In some cases the pressure is too large to allow any flow of liquid into the storage vessel. Depending on the type of filling method used, this can slow down or stop the filling process. In certain instances, the excess vapor pressure in the storage vessel is first fed back to the bulk liquefied natural gas storage vessel at the refueling station, while in other cases the excess vapor pressure is simply vented to the atmosphere. Both methods have drawbacks due to either complexity or environmental and economic considerations.

The invention can overcome these inefficiencies by recovering the gas in the vapor region of the storage vessel and condensing it against the colder supplied liquefied gas in a venturi device. This improves the vapor recovery and fueling process, while avoiding either discharge of gas to the atmosphere or venting back into the bulk storage vessel. Direct recovery into the bulk storage vessel introduces complexity, added cost, and may be unacceptable because of the resulting uncertain recovered gas composition. Further, direct recovery may be very difficult if the bulk storage vessel is at an elevated pressure, or if it causes venting of the bulk storage vessel, or alters the inventory of liquid fuel and increases lost product.

### SUMMARY OF THE INVENTION

In one embodiment of the invention, there is disclosed a method for the recovery of gas from a storage vessel comprising the steps of feeding liquid from a liquid supply through a venturi device to a storage vessel; feeding gas from the storage vessel to the venturi device; and combining the gas and liquid fed from the liquid supply in the venturi device to feed to the storage vessel.

In another embodiment of the invention, there is disclosed a method for the recovery of gas from a storage vessel comprising the steps of feeding liquid from a liquid supply through a venturi device to a storage vessel; feeding gas from the storage vessel to a heat exchange device thereby condensing the gas into a condensed liquid and feeding the condensed liquid to the venturi device; and combining the condensed liquid and liquid fed from the liquid supply in the venturi device to feed to the storage vessel.

The invention provides for a method for withdrawing gas from a storage vessel and combining this gas with fresh liquid feed using a venturi device for entry into the storage vessel. Typically this method is applicable to storage vessels that contain gas as well as liquid. The storage vessel can be a stationary storage vessel such as at a fueling station or it can be onboard a vehicle such as a truck or ship. The gas is withdrawn from the top of the storage vessel and fed to a venturi which will combine the gas with a feed of liquid from the liquid supply method and feed both to the storage vessel.

In many instances the fresh liquid supplied is sufficiently cold to cause full condensation of the recovered gas from the storage vessel, and the storage vessel pressure is quickly reduced and the gas reintroduced as liquid. If the fresh liquid is not sufficiently cold, or the onboard storage pressure is higher than the pressure of the fresh liquid, then an alternative arrangement can be used to pre-cool and possibly condense the gas prior to introduction into the venturi device and combining with the liquid feed.

The rate of gas withdrawal from the storage vessel can be increased if so desired by cooling, and preferably condensing, the gas prior to its contacting the liquid feed from the liquid supply method in the venturi device. This withdrawal of the gas from the storage vessel will reduce the pressure in the storage vessel and lessen the need to vent gas thereby minimizing losses of the fuel and the resulting environmental impact. Overall, this results in an increased filling flow into the storage vessel due to the greater pressure differential created by the lower pressure in the storage vessel versus that of the liquid supplied to it.

### BRIEF DESCRIPTION OF THE DRAWINGS

FIG. 1 is a schematic diagram of a venturi device in fluid communication with a liquid supply method and a storage vessel according to the invention.

FIG. 2 is a schematic diagram of a venturi device in fluid communication with a liquid supply method, heat exchange means and a storage vessel according to the invention.

### DETAILED DESCRIPTION OF THE INVENTION

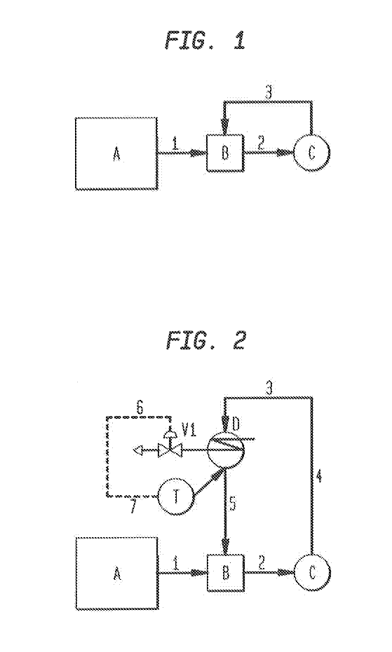

Turning to the figures, FIG. 1 is a schematic diagram showing the storage vessel, the liquid supply method and the venturi device. Gas, which is typically natural gas, is fed from the storage vessel C to the suction of a venturi device B through line 3. The venturi device B is driven by a motive flow of fresh liquid. This venturi device B may be any number of designs such as single nozzle exhausters or multi nozzle exhausters that produces vacuum by means of the venturi effect. As noted, the storage vessel can be either stationary such as storage vessels used at alternative fueling stations or it can be mobile or onboard a vehicle such as a truck or a ship.

The storage vessel C will be supplied with liquid by conventional filling means from liquid supply method A through line 1 to the venturi device B. The gas that is fed from the storage vessel C will be fed to the venturi device B through line 3 where it will combine and typically be condensed by the liquid that is being fed into the storage vessel from venturi device B through line 2.

In FIG. 2, an alternative embodiment is shown. Like drawing components are labeled the same as their counterparts in FIG. 1. Gas from the storage vessel C is fed to a venturi device B through lines 4 and 5 where it will combine with the liquid that is being fed by conventional means through line 1 from liquid supply method A into the storage vessel C.

In this embodiment, the gas that leaves the storage vessel C is first fed to a heat exchange device D through line 4 whereby the gas will be cooled and preferably condensed prior to it being returned to the venturi device B through line 5 where the condensed liquid will join with the liquid from the liquid supply method A through line 1. This combination of liquid and condensed liquid will be fed from the venturi device B through line 2 to the storage vessel C. The cooling provided to the heat exchanger may be from a variety of sources but is preferably liquid nitrogen. Care must be taken to avoid excessive cooling which may cause a severe pressure reduction. Any remaining gas is fed through line 6 to valve V1 where it can be vented to the atmosphere through the valve V1. The gas may also be collected from valve V1 through line 7 and returned at an appropriate temperature T to the heat exchange device D.

The invention relies on the venturi device B to assist in pulling the gas from the top of the storage vessel C into the flow of liquid from the liquid storage method A thereby providing the motive force for the liquid's entry into the storage vessel C. The recovered gas taken from the top of the storage vessel C which may already be cooled or partially condensed by the optional heat exchange device D will typically condense against the cold fresh liquid feed from liquid supply method A.

The effect of cooling and condensing the gas in the heat exchange device D will be a greater decrease in pressure in the storage vessel C allowing for a greater volume of fresh liquid that can be fed to the storage vessel C.

Additional benefits are realized by the methods of the present invention. Reducing the pressure in the storage vessel can reduce or eliminate the need to vent gas or return the gas to a bulk storage vessel from the storage vessel. In the situation where venting is avoided, it is beneficial both financially due to reduced losses of liquid and environmentally because there is a decrease in the release of gases such as natural gas which is a greenhouse gas. By avoiding returning gas to a liquid bulk storage vessel, several benefits are realized. These benefits include the reduction of added complexity and cost, as well as the ensuing uncertainty in the composition of the recovered gas. Further benefits include recovery when the storage vessel is at an elevated pressure as well as avoiding venting to the atmosphere and product losses resulting from said venting.

Reducing the pressure in the storage vessel will increase the pressure differential between the liquid supply method and the storage vessel. This will allow for an increased fill rate at the same liquid supply pressure or a decreased liquid supply pressure which may allow for a different (simpler and cheaper) liquid supply method to be employed.

Further reductions in the pressure due to cooling and/or liquefaction of the gas from the vapor space of the storage vessel will serve to effect these advantages or enhance them.

In other embodiments of the invention, the methods may be applicable to other cryogenic storage vessels whether they are vehicular based or stationary.

Alternative piping or instrumentation arrangements can be made to the configuration of the liquid supply and storage vessel. For example, the flow of recovered gas and/or fresh liquid to the venturi device may be restricted dependent upon the pressure of the storage vessel.

Additional control elements such as valving and piping could be used to enable the inventive method to occur when the storage vessel and the liquid filling method only have a one hose connection to the vapor space.

The reduction of liquid supply pressure could enable liquid supply methods to reduce their operating pressure and thereby reduce costs. Bulk liquid storage vessels could run at lower pressures and can thus be made with thinner wall thicknesses saving costs in construction.

Any pumps that would be necessary would be those requiring a lower discharge head and reduced cost.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for the recovery of gas from a storage vessel comprising the steps of feeding liquid from a liquid supply through a venturi device to a storage vessel; feeding gas from the storage vessel to the venturi device; and combining the gas and liquid fed from the liquid supply in the venturi device, and feed to the storage vessel.

2. The method as claimed in claim 1 wherein the gas is natural gas and the liquid is liquefied natural gas.

3. The method as claimed in claim 1 wherein the venturi device is selected from the group consisting of single nozzle exhausters and multi nozzle exhausters.

4. The method as claimed in claim 1 wherein the storage vessel is onboard a vehicle.

5. The method as claimed in claim 1 wherein the storage vessel is stationary.

6. The method as claimed in claim 1 wherein the gas condenses in the venturi device.

7. The method as claimed in claim 1 wherein the temperature of the liquid from the liquid supply is sufficiently cold to condense the gas in the venturi device.

8. The method as claimed in claim 1 wherein the pressure of the storage vessel is reduced before the combination of gas and liquid is fed from the venturi device to the storage vessel.

9. A method for the recovery of gas from a storage vessel comprising the steps of feeding liquid from a liquid supply through a venturi device to a storage vessel; feeding gas from the storage vessel to a heat exchange device thereby condensing the gas into a condensed liquid and feeding the condensed liquid to the venturi device; and combining the condensed liquid and liquid fed from the liquid supply in the venturi device to feed to the storage vessel.

10. The method as claimed in claim 9 wherein the gas is natural gas and the liquid is liquefied natural gas.

11. The method as claimed in claim 9 wherein the venturi device is selected from the group consisting of single nozzle exhausters and multi nozzle exhausters.

12. The method as claimed in claim 9 wherein the storage vessel is onboard a vehicle.

13. The method as claimed in claim 9 wherein the storage vessel is stationary.

14. The method as claimed in claim 9 wherein the pressure of the storage vessel is reduced before the combination of gas and liquid is fed from the venturi device to the storage vessel.

15. The method as claimed in claim 9 wherein the pressure differential between the liquid supply method and the storage vessel increases.

16. The method as claimed in claim 9 further comprising venting the gas from the heat exchange device.

17. The method as claimed in claim 9 wherein gas is recycled to the heat exchange device.
